(19) United States
(12) Patent Application Publication
(10) Pub. No.: US 2025/0303691 A1
(43) Pub. Date: Oct. 2, 2025

(54) LIQUID EJECTION APPARATUS AND METHOD OF INSPECTING SAME

(71) Applicant: SEIKO EPSON CORPORATION, Tokyo (JP)

(72) Inventor: Daichi ORIHARA, Shiojiri (JP)

(21) Appl. No.: 19/090,649

(22) Filed: Mar. 26, 2025

(30) Foreign Application Priority Data
Mar. 28, 2024 (JP) 2024-053383

(51) Int. Cl. B41J 2/045; B41J 2/17

(52) U.S. Cl. CPC B41J 2/0451; B41J 2/04573; B41J 2/04581; B41J 2/04588; B41J 2/1707

(57) ABSTRACT

A liquid ejection apparatus includes a plurality of ejection units configured to eject the liquid with which the plurality of ejection units is filled, a generation section configured to generate first rank information based on a detection result of a vibration generated in a first ejection unit out of the plurality of ejection units in a state where the first ejection unit is filled with a first liquid, and an inspection section configured to inspect the first ejection unit based on a detection result of a vibration generated in the first ejection unit in a state where the first ejection unit is filled with a second liquid, and the first rank information wherein the first rank information represents a rank to which the first ejection unit belongs when classifying the plurality of ejection units into a plurality of ranks based on vibration characteristics of the plurality of ejection units.

The present application is based on, and claims priority from JP Application Serial Number 2024-053383, filed Mar. 28, 2024, the disclosure of which is hereby incorporated by reference herein in its entirety.

### BACKGROUND

### 1. Technical Field

The present disclosure relates to a liquid ejection apparatus and a method of inspecting a liquid ejection apparatus.

### 2. Related Art

A liquid ejection apparatus such as an inkjet printer drives each of a plurality of ejection units to thereby eject a liquid such as ink, with which each of the ejection units is filled, to form an image on a medium (the liquid such as ink for forming an image on the medium is hereinafter referred to as a “printing liquid”. An example of a “second liquid”). However, in the liquid ejection apparatus, an ejection abnormality in which the printing liquid cannot be normally ejected from the ejection unit may occur in some cases. Therefore, in the past, a technology of inspecting the ejection units has been proposed. For example, JP-A-2012-179873 discloses a technique of classifying a plurality of ejection units into a plurality of ranks based on the characteristics of vibration of each of the ejection units, and then inspecting each of the ejection units based on a criterion corresponding to the rank which the ejection unit belongs to.

JP-A-2012-179873 is an example of the related art.

However, according to the related art, when classifying the plurality of ejection units into the plurality of ranks, it is necessary to fill the plurality of ejection units with the printing liquid, and further, it is also necessary to eject the printing liquid from the plurality of ejection units in some cases. Therefore, according to the related art, for example, when performing the operation of classifying the plurality of ejection units into the plurality of ranks before the product shipment of the liquid ejection apparatus, it is necessary to fill the plurality of ejection units with the printing liquid before the product shipment of the liquid ejection apparatus. Further, according to the related art, for example, when the operation of classifying the plurality of ejection units into the plurality of ranks is performed at a timing other than the timing at which the liquid ejection apparatus performs processing of forming an image on the medium, it is necessary to consume the printing liquid besides the purpose of forming an image on the medium. In these cases, the consumption of the printing liquid may increase in some cases.

### SUMMARY

In view of the problems described above, a liquid ejection apparatus according to the present disclosure includes a plurality of ejection units which is filled with a liquid, and is configured to eject the liquid with which the plurality of ejection units is filled, a generation n configured to generate first rank information based on a detection result of a vibration generated in a first ejection unit out of the plurality of ejection units in a state where the first ejection unit is filled with a first liquid, and an inspection section configured to inspect the first ejection unit based on a detection result of a vibration generated in the first ejection unit in a state where the first ejection unit is filled with a second liquid, and the first rank information wherein the first rank information represents a rank to which the first ejection unit belongs when classifying the plurality of ejection units into a plurality of ranks based on vibration characteristics of the plurality of ejection units.

Further, a method of inspecting a liquid ejection apparatus according to the present disclosure is a method of inspecting a liquid ejection apparatus including a plurality of ejection units configured to eject a liquid with which the plurality of ejection units is filled, including generating first rank information based on a detection result of a vibration generated in a first ejection unit out of the plurality of ejection units in a state where the first ejection unit is filled with a first liquid, and inspecting the first ejection unit based on a detection result of a vibration generated in the first ejection unit in a state where the first ejection unit is filled with a second liquid, and the first rank information wherein the first rank information represents a rank to which the first ejection unit belongs when classifying the plurality of ejection units into a plurality of ranks based on vibration characteristics of the plurality of ejection units.

### BRIEF DESCRIPTION OF THE DRAWINGS

FIG. 1 is a block diagram showing an example of a configuration of an inkjet printer 1 according to an embodiment of the present disclosure.

FIG. 2 is a perspective view showing an example of a schematic structure of the inkjet printer 1.

FIG. 3 is a cross-sectional view illustrating an example of a structure of an ejection unit D[m].

FIG. 4 is a block diagram showing an example of a configuration of a head unit 3.

FIG. 5 is a timing chart illustrating an example of signals supplied to the head unit 3.

FIG. 6 is a diagram illustrating an example of individual designation signals Sd[m].

FIG. 7 is a diagram illustrating an example of the individual designation signals Sd[m].

FIG. 8 is a timing chart illustrating an example of a detection signal SK[m].

FIG. 9 is a diagram illustrating an example of attributed rank information QR.

FIG. 10 is a diagram illustrating an example of in-preservation proper vibration information QP.

FIG. 11 is a diagram illustrating an example of in-use proper vibration information QS.

FIG. 12 is a diagram illustrating an example of a relationship between in-preservation proper range information QPP and in-use proper range information QSS.

FIG. 13 is a flowchart illustrating an example of rank information generation processing.

FIG. 14 is a flowchart illustrating an example of ejection state inspection processing.

FIG. 15 is a block diagram showing an example of a configuration of an inkjet printer 1B according to Modified Example 1 of the present disclosure.

### DESCRIPTION OF EMBODIMENTS

An aspect for implementing the present disclosure will hereinafter be described with reference to the drawings. However, in the drawings, dimensions and scales of the elements are made different from actual ones as appropriate. Further, the following embodiment is preferable specific example of the present disclosure and therefore various technically preferable limitations are imposed thereon, however, the scope of the present disclosure is not limited to the embodiment unless there is a description that the present disclosure is limited thereto in particular in the following description.

### A. Embodiment

In the present embodiment, a liquid ejection apparatus will be described exemplifying an inkjet printer that ejects ink to form an image on recording paper PP.

### 1. Overview of Inkjet Printer

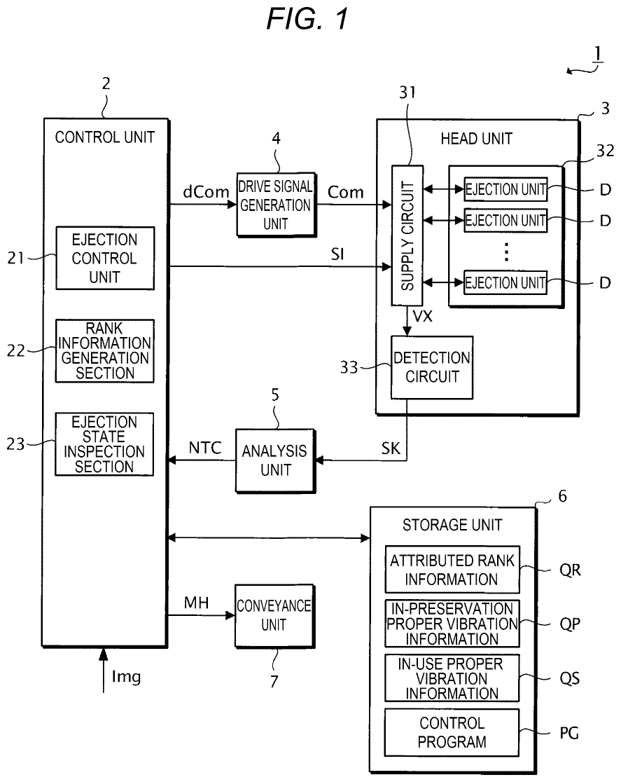

An example of a configuration of an inkjet printer 1 according to the present embodiment will hereinafter be described with reference to FIGS. 1 to 3.

FIG. 1 is a functional block diagram showing an example of the configuration of the inkjet printer 1.

As shown in FIG. 1, print data Img representing an image for the inkjet printer 1 to form is supplied to the inkjet printer 1 from a host computer such as a personal computer or a digital camera. The inkjet printer 1 executes print processing of forming the image represented by the print data Img supplied from the host computer on the recording paper PP.

As shown in FIG. 1, the inkjet printer 1 includes a control unit 2 that controls each section of the inkjet printer 1, a head unit 3 provided with ejection units D that eject ink, a drive signal generation unit 4 that generates drive signals Com for driving the ejection units D, an analysis unit 5 that analyzes a detection result of a vibration generated in the ejection units D, a storage unit 6 that stores various types of information, and a conveyance unit 7 for changing a relative position of the recording paper PP to the head unit 3.

Note that in the present embodiment, the inkjet printer 1 is an example of a “liquid ejection apparatus”.

In the present embodiment, there is assumed when the inkjet printer 1 includes a single head unit 3 or a plurality of head units 3, a single drive signal generation unit 4 or a plurality of drive signal generation units 4 corresponding one-to-one to the single head unit 3 or the plurality of head units 3, and a single analysis unit 5 or a plurality of analysis units 5 corresponding one-to-one to the single head unit 3 or the plurality of head units 3. Specifically, in the present embodiment, there is assumed when the inkjet printer 1 includes the four head units 3, the four drive signal generation units 4 corresponding one-to-one to the four head units 3, and the four analysis units 5 corresponding to one-to-one to the four head units 3. However, hereinafter, for the sake of convenience of explanation, as shown in FIG. 1, the description will be presented with a focus on one of the four head units 3, one of the drive signal generation units 4 provided so as to correspond to that one head unit 3, and one of the four analysis units 5 provided so as to correspond to that one head unit 3.

The control unit 2 includes a single central processing unit (CPU) or a plurality of CPUs. However, the control unit 2 may include a programmable logic device such as a field-programmable gate array (FPGA) in place of or in addition to the CPU.

The storage unit 6 is configured including either one or both of a volatile memory such as a random access memory (RAM) and a nonvolatile memory such as a read-only memory (ROM), an electrically erasable programmable read-only memory (EEPROM), or a programmable ROM (PROM). The storage unit 6 stores a control program PG of the inkjet printer 1, attributed rank information QR, in-preservation proper vibration information QP, and in-use proper vibration information QS. Note that the attributed rank information QR, the in-preservation proper vibration information QP, and the in-use proper vibration information QS will be described later.

Note that in the present embodiment, the in-preservation proper vibration information QP is an example of “first reference information”, and the in-use proper vibration information QS is an example of “second reference information”.

The control unit 2 can function as an ejection control unit 21, a rank information generation section 22, and an ejection state inspection section 23 by executing the control program PG stored in the storage unit 6 and operating in accordance with the control program PG.

Note that in the present embodiment, the rank information generation section 22 is an example of a “generation section”, and the ejection state inspection section 23 is an example of an “inspection section”.

The ejection control unit 21 generates a waveform designation signal dCom and supplies the waveform designation signal dCom thus generated to the drive signal generation unit 4. Here, the waveform designation signals dCom are digital signals that define waveforms of the drive signals Com. The drive signals Com are analog signals for driving the ejection units D. The drive signal generation unit 4 generates the drive signals Com having waveforms defined by the waveform designation signals dCom, and supplies the drive signals Com thus generated to the head unit 3.

The ejection control unit 21 generates a designation signal SI and supplies the designation signal SI thus generated to the head unit 3. Here, the designation signal SI is a digital signal for designating types of operations of the ejection units D. Specifically, the designation signal SI is a signal that designates the types of operations of the ejection units D by designating whether to supply the drive signals Com to the ejection units D.

The rank information generation section 22 generates the attributed rank information QR based on the in-preservation proper vibration information QP. A series of processing related to generation of the attributed rank information QR by the rank information generation section 22 will hereinafter be referred to as rank information generation processing.

The ejection state inspection section 23 inspects an ejection state of the ink in the ejection units D based on the in-use proper vibration information QS. A series of processing related to the inspection of the ejection state of the ink in the ejection units D by the ejection state inspection section 23 will hereinafter be referred to as ejection state inspection processing.

The head unit 3 includes a supply circuit 31, a recording head 32, and a detection circuit 33.

The recording head 32 includes M ejection units D. Here, the value M is a natural number satisfying “M≥2”. Note that hereinafter, the m-th ejection unit D of the M ejection units D provided to the recording head 32 may be referred to as an “ejection unit D[m]” in some cases. Here, the variable m is a natural number satisfying “1≤m≤M”. Further, hereinafter, when a constituent, a signal, or the like of the inkjet printer 1 corresponds to the ejection unit D[m] of the M ejection units D, [m] may be indexed to the reference symbol denoting the constituent, the signal, or the like in some cases.

The supply circuit 31 switches whether to supply the drive signals Com to the ejection unit D[m] based on the designation signal SI. Hereinafter, out of the drive signals Com, the drive signal Com supplied to the ejection unit D[m] may be referred to as a supply drive signal Vin[m] in some cases.

The supply circuit 31 switches whether to supply the detection circuit 33 with a vibration signal VX[m] representing a potential of an upper electrode Zu[m] provided to a piezoelectric element PZ[m] provided to the ejection unit D[m] based on the designation signal SI. Hereinafter, when the vibration signal VX[m] is supplied from the ejection unit D[m] to the detection circuit 33, the ejection unit D[m] may be referred to as an inspection target ejection unit DK. Note that the piezoelectric element PZ[m] and the upper electrode Zu[m] will be described later with reference to FIG. 3.

The detection circuit 33 generates a detection signal SK[m] based on the vibration signal VX[m] supplied from the ejection unit D[m] defined as the inspection target ejection unit DK via the supply circuit 31. Specifically, the detection circuit 33 amplifies the vibration signal VX[m] to thereby generate the detection signal SK[m].

Based on the detection signal SK[m] output from the detection circuit 33, the analysis unit 5 analyzes the waveform of the vibration generated in the ejection unit D[m] driven as the inspection target ejection unit DK to extract information representing the characteristics of the vibration. In the present embodiment, as an example, it is assumed that the analysis unit 5 generates period information NTC[m] representing the period TC[m] of the vibration generated in the ejection unit D[m] driven as the inspection target ejection unit DK based on the detection signal SK[m]. However, the present disclosure is not limited to such an aspect. The analysis unit 5 may generate information including some or all of the period TC[m], an amplitude, and a phase of the vibration generated in the ejection unit D[m] driven as the inspection target ejection unit DK based on the detection signal SK[m].

Note that as described above, in the present embodiment, the inkjet printer 1 executes the print processing, the rank information generation processing, and the ejection state inspection processing. Further, in the present embodiment, there is assumed when the print processing and the ejection state inspection processing are executed after the inkjet printer 1 is shipped, and in a state where the ejection units D are filled with the ink, and the ink can be ejected from the ejection units D. Further, in the present embodiment, there is assumed when the rank information generation processing is executed before the inkjet printer 1 is shipped, and in a state where the ejection units D are filled with a preservative solution. In this case, the preservative solution may be a liquid that is not used by the inkjet printer 1 for forming an image in the print processing. Further, the preservative solution may be a liquid for protecting the ejection units D provided to the inkjet printer 1 before shipment of the inkjet printer 1. Further, the preservative solution may be an antifreeze liquid for preventing freezing of the ejection units D provided to the inkjet printer 1 before shipment of the inkjet printer 1.

However, the present disclosure is not limited to such an aspect. The rank information generation processing may be executed after shipment of the inkjet printer 1, in the state where the ejection units D are filled with the preservative solution. Also in this case, the preservative solution may be the liquid that is not used by the inkjet printer 1 for forming an image in the print processing. The preservative solution may be a liquid for cleaning flow paths communicating with the ejection units D provided to the inkjet printer 1.

When the print processing is executed, the ejection control unit 21 generates a signal such as the designation signal SI for controlling the head unit 3 based on the print data Img. Further, the ejection control unit 21 generates signals such as the waveform designation signals dCom for controlling the drive signal generation unit 4. Further, the control unit 2 generates a conveyance control signal MH for controlling the conveyance unit 7. Thus, in the print processing, the control unit 2 adjusts the presence or absence of ejection of the ink from the ejection unit D[m], the ejection amount of the ink, the ejection timing of the ink, and so on while controlling the conveyance unit 7 to change the relative position of the recording paper PP to the head unit 3, and controls every unit of the inkjet printer 1 so that an image corresponding to the print data Img is formed on the recording paper PP.

When the rank information generation processing is executed, the ejection control unit 21 supplies the head unit 3 with the designation signal SI for driving the ejection unit D[m] as the inspection target ejection unit DK. Further, the head unit 3 outputs the detection signal SK[m] representing the vibration generated in the ejection unit D[m] as a result that the ejection unit D[m] is driven as the inspection target ejection unit DK. Then, the analysis unit 5 generates the period information NTC[m] representing the period TC[m] of the vibration generated in the ejection unit D[m] based on the detection signal SK[m]. The rank information generation section 22 generates the attributed rank information QR based on the period information NTC[m] and the in-preservation proper vibration information QP.

Here, the attributed rank information QR is information representing the rank to which each of the M ejection units D[1] to D[M] belongs when the M ejection units D[1] to D[M] provided to the head unit 3 are classified into a plurality of ranks based on the period TC[m] of the vibration generated in the ejection unit D[m]. Hereinafter, out of the ranks of the M ejection units D[1] to D[M] represented by the attributed rank information QR, the rank to which the ejection unit D[m] belongs is referred to as a rank RK[m]. Further, in the present embodiment, it is assumed that the M ejection units D[1] to D[M] provided to the head unit 3 are classified into R ranks. Here, the value R is a natural number satisfying “2≤R<M”.

Further, the in-preservation proper vibration information QP is information representing a proper range of the period TC[m] of the vibration generated in the ejection unit D[m] driven as the inspection target ejection unit DK in a state where the ejection unit D[m] belonging to each rank r is filled with the preservative solution. Here, the variable r is a natural number satisfying “1≤r≤R”.

When the ejection state inspection processing is executed, the ejection control unit 21 supplies the head unit 3 with the designation signal SI for driving the ejection unit D[m] as the inspection target ejection unit DK. Further, the head unit 3 outputs the detection signal SK[m] representing the vibration generated in the ejection unit D[m] as a result that the ejection unit D[m] is driven as the inspection target ejection unit DK. Then, the analysis unit 5 generates the period information NTC[m] representing the period TC[m] of the vibration generated in the ejection unit D[m] based on the detection signal SK[m]. Then, the ejection state inspection section 23 inspects an ejection state of the ink in the ejection units D based on the period information NTC[m] and the in-use proper vibration information QS. In other words, the ejection state inspection section 23 inspects whether an ejection abnormality has occurred in the ejection unit D[m] based on the period information NTC[m] and the in-use proper vibration information QS.

Here, the ejection abnormality is a generic term of a state where the ink fails to normally be ejected from a nozzle N provided to the ejection unit D[m]. For example, the ejection abnormality includes a state where the ejection unit D[m] becomes unable to eject the ink, a state where the ejection unit D[m] ejects a different amount of ink from the ejection amount of ink defined by the drive signal Com, a state where the ejection unit D[m] ejects the ink at a speed different from the ejection speed of the ink defined by the drive signal Com, and so on.

Further, the in-use proper vibration information QS is information representing a proper range of the period TC[m] of the vibration generated in the ejection unit D[m] driven as the inspection target ejection unit DK in a state where the ejection unit D[m] belonging to each rank r is filled with the ink.

Note that hereinafter, the period TC[m] of the detection signal SK[m] detected from the ejection unit D[m] driven as the inspection target ejection unit DK in a state where the ejection unit D[m] is filled with the preservative solution may be referred to as a period TC-P[m], and the period information NTC[m] representing the period TC-P[m] may be referred to as period information NTC-P[m] in some cases. Further, hereinafter, the period TC[m] of the detection signal SK[m] detected from the ejection unit D[m] driven as the inspection target ejection unit DK in a state where the ejection unit D[m] is filled with the ink may be referred to as a period TC-S[m], and the period information NTC[m] representing the period TC-S[m] may be referred to as period information NTC-S[m] in some cases.

Note that in the present embodiment, the preservative solution is an example of a “first liquid”, and the ink is an example of a “second liquid”.

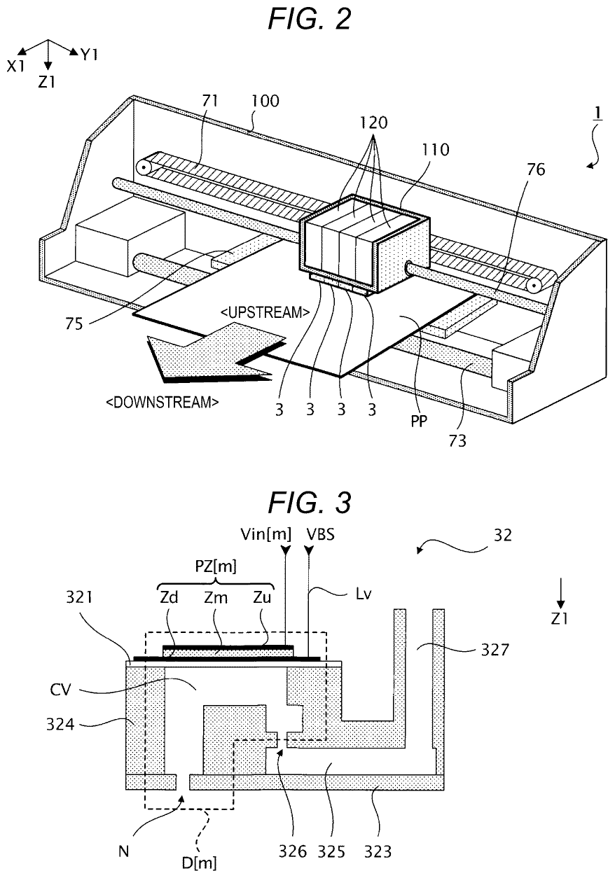

FIG. 2 is a perspective view showing an example of a schematic internal structure of the inkjet printer 1.

As shown in FIG. 2, in the present embodiment, there is assumed when the inkjet printer 1 is a serial printer. Specifically, when executing the print processing, the inkjet printer 1 forms dots corresponding to the print data Img on the recording paper PP by ejecting the ink from the ejection units D[m] while reciprocating the head unit 3 in a Y1 direction crossing an X1 direction and a Y2 direction opposite to the Y1 direction while conveying the recording paper PP in the X1 direction.

Hereinafter, the X1 direction and an X2 direction opposite thereto are collectively referred to as an “X-axis direction”, the Y1 direction crossing the X-axis direction and the Y2 direction opposite thereto are collectively referred to as a “Y-axis direction”, and a Z1 direction crossing the X-axis direction and the Y-axis direction and a Z2 direction opposite thereto are collectively referred to as a “Z-axis direction”. In the present embodiment, the description will be presented assuming when the X-axis direction, the Y-axis direction, and the Z-axis direction are orthogonal to each other as an example. However, the present disclosure is not limited to such an aspect. It is sufficient for the X-axis direction, the Y-axis direction, and the Z-axis direction to cross each other. Note that in the present embodiment, it is assumed that the Z1 direction is a direction in which the ink is ejected from the ejection unit D[m].

As shown in FIG. 2, the inkjet printer 1 according to the present embodiment includes a housing 100 and a carriage 110 on which the four head units 3 are mounted, and which can reciprocate in the Y-axis direction in the housing 100.

In the present embodiment, as shown in FIG. 2, there is assumed when the carriage 110 holds four ink cartridges 120 corresponding one-to-one to for colors of ink of cyan ink, magenta ink, yellow ink, and black ink. Further, in the present embodiment, as described above, there is assumed when the inkjet printer 1 includes the four head units 3 corresponding one-to-one to the four ink cartridges 120. Each of the ejection units D[m] is supplied with the ink from the ink cartridge 120 corresponding to the head unit 3 provided with that ejection unit D[m]. In this way, each of the ejection units D[m] can be filled with the ink thus supplied and eject the ink, with which the ejection unit D[m] is filled, from the nozzle N. Note that the ink cartridges 120 may be disposed outside the carriage 110.

Note that in the present embodiment, there is assumed when the ink cartridges 120 are not mounted on the carriage 110 before shipment of the inkjet printer 1. Further, in the present embodiment, there is assumed when the ejection units D[m] are filled with the preservative solution before shipment of the inkjet printer 1.

Further, as described above, the inkjet printer 1 according to the present embodiment includes the conveyance unit 7. The conveyance unit 7 includes a carriage carrying mechanism 71 for reciprocating the carriage 110 in the Y-axis direction, a carriage guide shaft 76 for supporting the carriage 110 so as to freely reciprocate in the Y-axis direction, a medium conveyance mechanism 73 for conveying the recording paper PP, and a platen 75 provided at the Z1 direction side of the carriage 110. Accordingly, when the print processing is executed, the conveyance unit 7 changes the relative position of the recording paper PP to the head unit 3 by reciprocating the head unit 3 together with the carriage 110 in the Y-axis direction along the carriage guide shaft 76 with the carriage carrying mechanism 71, and conveying the recording paper PP on the platen 75 in the X1 direction with the medium conveyance mechanism 73, and makes landing of the ink droplet onto the entire area of the recording paper PP possible.

FIG. 3 is a schematic partial cross-sectional view of the recording head 32 when cutting the recording head 32 so as to include the ejection unit D[m].

As shown in FIG. 3, the ejection unit D[m] includes a piezoelectric element PZ[m], a cavity CV[m] filled with the ink or the preservative solution, the nozzle N[m] communicating with the cavity CV[m], and a vibrating plate 321.

The ejection unit D[m] ejects the ink in the cavity CV[m] from the nozzle N[m] by the piezoelectric element PZ[m] being driven by the supply drive signal Vin[m]. The cavity CV[m] is a space defined by a cavity plate 324, a nozzle plate 323 in which the nozzle N[m] is formed, and the vibrating plate 321. The cavity CV[m] communicates with a reservoir 325 via an ink supply port 326. The reservoir 325 communicates with the ink cartridge 120 corresponding to the ejection unit D[m] via an ink intake port 327. The piezoelectric element PZ[m] includes the upper electrode Zu[m], a lower electrode Zd[m], and a piezoelectric body Zm[m] disposed between the upper electrode Zu[m] and the lower electrode Zd[m]. The lower electrode Zd[m] is electrically coupled to a feed line Lv set at a predetermined potential VBS. Then, when the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction or the Z2 direction in accordance with the voltage applied, and as a result, the piezoelectric element PZ[m] vibrates. The lower electrode Zd[m] is bonded to the vibrating plate 321. Accordingly, when the piezoelectric element PZ[m] is driven by the supply drive signal Vin[m] and vibrates, the vibrating plate 321 also vibrates. Then, the volume of the cavity CV[m] and the pressure in the cavity CV[m] change due to the vibration of the vibrating plate 321, and the ink which fills the inside of the cavity CV[m] is ejected from the nozzle N[m].

### 2. Overview of Head Unit

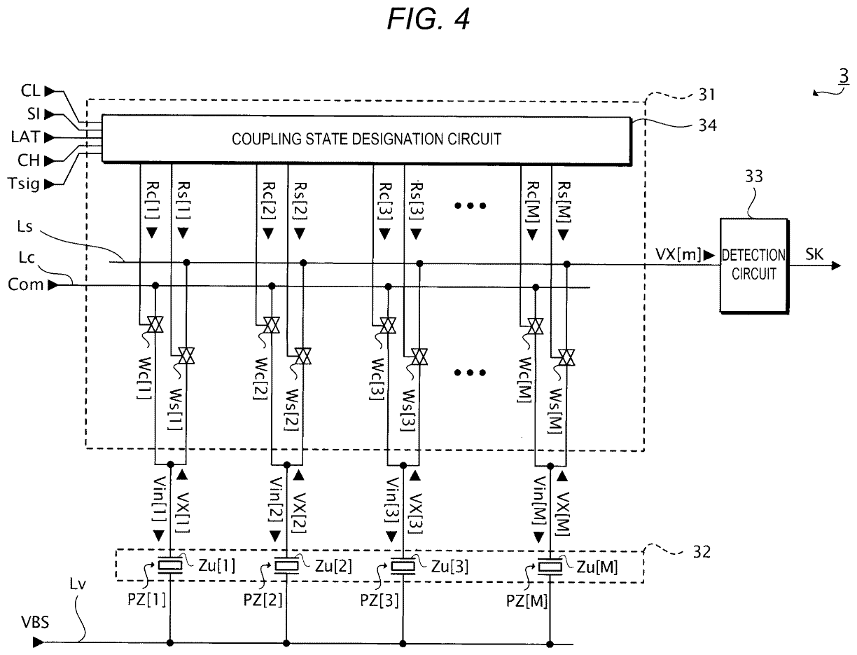

An overview of the head unit 3 will hereinafter be described with reference to FIGS. 4 to 7.

FIG. 4 is a block diagram showing an example of the configuration of the head unit 3.

As shown in FIG. 4, the head unit 3 includes the supply circuit 31, the recording head 32, and the detection circuit 33. The head unit 3 includes a wiring line Lc supplied with the drive signal Com from the drive signal generation unit 4, and a wiring line Ls for supplying the vibration signal VX[m] to the detection circuit 33.

The supply circuit 31 includes M switches Wc[1] to Wc[M] corresponding one-to-one to the M ejection units D[1] to D[M], M switches Ws[1] to Ws[M] corresponding one-to-one to the M ejection units D[1] to D[M], and a coupling state designation circuit 34 for designating coupling states of the respective switches.

The coupling state designation circuit 34 generates a coupling state designation signal Rc[m] for designating ON and OFF of the switch Wc[m] and a coupling state designation signal Rs[m] for designating ON and OFF of the switch Ws[m] based on the designation signal SI, a latch signal LAT, a change signal CH, and a period designation signal Tsig supplied from the control unit 2.

The switch Wc[m] switches conduction and non-conduction between the wiring line Lc and the upper electrode Zu[m] of the piezoelectric element PZ[m] based on the coupling state designation signal Rc[m]. In the present embodiment, the switch Wc[m] is turned ON when the coupling state designation signal Rc[m] is at a high level, and is turned OFF when the signal is at a low level. When the switch Wc[m] is turned ON, the drive signal Com supplied to the wiring line Lc is supplied to the upper electrode Zu[m] of the ejection unit D[m] as the supply drive signal Vin[m].

The switch Ws[m] switches conduction and non-conduction between the wiring line Ls and the upper electrode Zu[m] of the piezoelectric element PZ[m] based on the coupling state designation signal Rs[m]. In the present embodiment, the switch Ws[m] is turned ON when the coupling state designation signal Rs[m] is at the high level, and is turned OFF when the signal is at the low level. When the switch Ws[m] is turned ON, the vibration signal VX[m] representing the potential of the upper electrode Zu[m] provided to the ejection unit D[m] is supplied from the upper electrode Zu[m] to the detection circuit 33 via the wiring line Ls.

The detection circuit 33 generates the detection signal SK[m] having a waveform corresponding to the waveform of the vibration signal VX[m] based on the vibration signal VX[m] supplied from the wiring line Ls. Specifically, the detection circuit 33 amplifies the vibration signal VX[m] to thereby generate the detection signal SK[m].

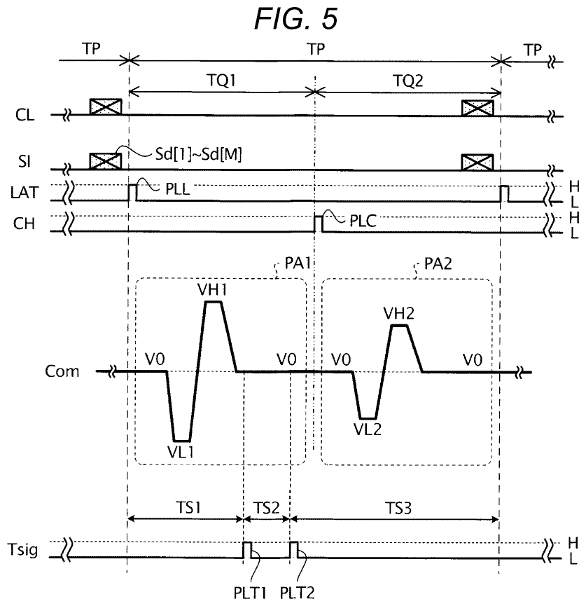

FIG. 5 is a timing chart showing an example of various signals such as the drive signal Com supplied to the head unit 3.

As shown in FIG. 5, in the present embodiment, when the inkjet printer 1 executes the print processing, the rank information generation processing, or the ejection state inspection processing, a single unit period TP or a plurality of unit periods TP is set as the operation period of the inkjet printer 1. The inkjet printer 1 can drive the ejection units D[m] in each unit period TP.

As shown in FIG. 5, the control unit 2 outputs a latch signal LAT having a pulse PLL. Thus, the control unit 2 defines the unit period TP as a period from a rising edge of the pulse PLL to a rising edge of the subsequent pulse PLL.

Further, the control unit 2 outputs the change signal CH having a pulse PLC in the unit period TP. Further, the control unit 2 divides the unit period TP into a driving period TQ1 from the rising edge of the pulse PLL to a rising edge of the pulse PLC and a driving period TQ2 from the rising edge of the pulse PLC to the rising edge of the pulse PLL.

Further, the control unit 2 outputs the period designation signal Tsig having a pulse PLT1 and a pulse PLT2 in the unit period TP. Then, the control unit 2 divides the unit period TP into a control period TS1 from the rising edge of the pulse PLL to a rising edge of the pulse PLT1, a control period TS2 from the rising edge of the pulse PLT1 to a rising edge of the pulse PLT2, and a control period TS3 from the rising edge of the pulse PLT2 to the rising edge of the pulse PLL.

As shown in FIG. 5, the designation signal SI includes M individual designation signals Sd[1] to Sd[M] corresponding one-to-one to the M ejection units D[1] to D[M]. The individual designation signal Sd[m] designates the drive mode of the ejection unit D[m] in each unit period TP when the inkjet printer 1 executes the print processing, the rank information generation processing, or the ejection state inspection processing. Prior to each unit period TP, the control unit 2 supplies the designation signal SI containing the M individual designation signals Sd[1] to Sd[M] to the coupling state designation circuit 34 in synchronization with a clock signal CL. Then, in that unit period TP, the coupling state designation circuit 34 generates the coupling state designation signal Rc[m] and the coupling state designation signal Rs[m] based on the individual designation signal Sd[m].

Note that in the present embodiment, it is assumed that the ejection unit D[m] can form any one of a large dot formed of the ink having an ink amount ξ1 and a small dot formed of the ink having an ink amount ξ2 smaller than the ink amount ξ1 when the inkjet printer 1 executes the print processing.

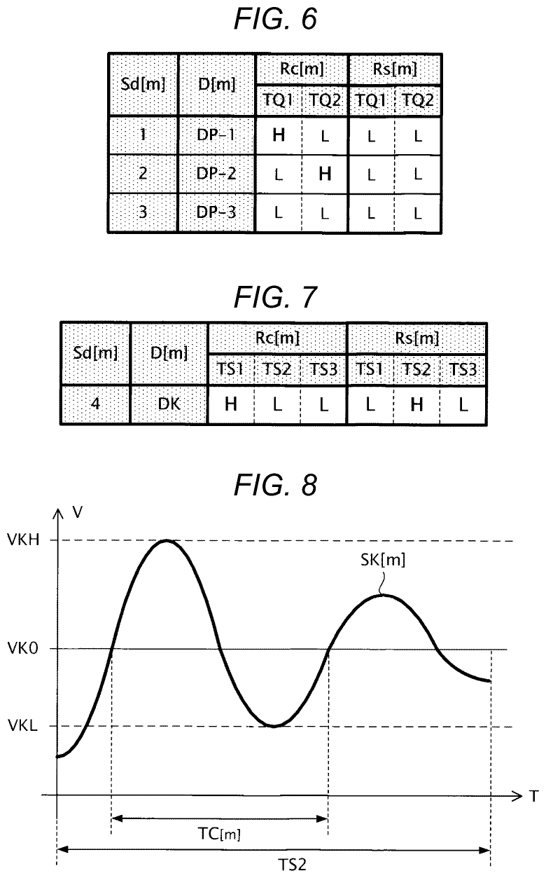

FIGS. 6 and 7 are diagrams illustrating an example of the individual designation signal Sd[m].

As shown in FIGS. 6 and 7, in the present embodiment, the individual designation signal Sd[m] represents any one of four values in the unit period TP: a value “1” for designating the ejection unit D[m] as a large dot forming ejection unit DP-1; a value “2” for designating the ejection unit D[m] as a small dot forming ejection unit DP-2; a value “3” for designating the ejection unit D[m] as a non-driven ejection unit DP-3; and a value “4” for designating the ejection unit D[m] as the inspection target ejection unit DK.

Here, the large dot forming ejection unit DP-1 is the ejection unit D that forms the large dot in the unit period TP. The small dot formation ejection unit DP-2 is the ejection unit D that forms the small dot in the unit period TP. The non-driven ejection unit DP-3 is the ejection unit D that is not driven by the drive signal Com in the unit period TP. The inspection target ejection unit DK is the ejection unit D to be subjected to the rank information generation processing and the ejection state inspection processing in the unit period TP.

The description returns to FIG. 5.

As shown in FIG. 5, in the present embodiment, the drive signal Com has a waveform PA1 provided in the driving period TQ1 and a waveform PA2 provided in the driving period TQ2.

Out of these waveforms, the waveform PA1 is a waveform which returns to a reference potential V0 from the reference potential V0 via a potential VL1 lower than the reference potential V0 and a potential VH1 higher than the reference potential V0 in the control period TS1 of the driving period TQ1, and keeps the reference potential V0 in the control period TS2 and the control period TS3 of the driving period TQ1. The waveform PA1 is determined so that the ink corresponding to the ink amount ξ1 is ejected from the ejection unit D[m] when the supply drive signal Vin[m] having the waveform PA1 is supplied to the ejection unit D[m].

Further, the waveform PA2 is a waveform which returns from the reference potential V0 to the reference potential V0 through a potential VL2 lower than the reference potential V0 and a potential VH2 higher than the reference potential V0 in the driving period TQ2. The waveform PA2 is determined so that the ink corresponding to the ink amount ξ2 is ejected from the ejection unit D[m] when the supply drive signal Vin[m] having the waveform PA2 is supplied to the ejection unit D[m].

Note that in the present embodiment, as an example, there is assumed when the volume of the cavity CV[m] provided to the ejection unit D[m] becomes smaller when the potential of the supply drive signal Vin[m] supplied to the ejection unit D[m] is a high potential, compared to when the potential is a low potential. Therefore, when the ejection unit D[m] is driven by the supply drive signal Vin[m] having the waveform PA1 or the like, the potential of the supply drive signal Vin[m] changes from the low potential to the high potential to thereby eject the ink in the ejection unit D[m] from the nozzle N[m].

Then, the operation of the ejection unit D[m] designated by the individual designation signal Sd[m] will be described with reference to FIGS. 6 and 7.

As shown in FIG. 6, when the individual designation signal Sd[m] represents the value “1” that designates the ejection unit D[m] as the large dot forming ejection unit DP-1 in the unit period TP, the coupling state designation circuit 34 sets the coupling state designation signal Rc[m] to the high level in the driving period TQ1. In this case, the switch Wc[m] is turned ON in the driving period TQ1. Accordingly, the ejection unit D[m] is driven by the supply drive signal Vin[m] having the waveform PA1 in the unit period TP, and ejects the ink having the ink amount ξ1 corresponding to the large dot.

Further, when the individual designation signal Sd[m] represents the value “2” that designates the ejection unit D[m] as the small dot forming ejection unit DP-2 in the unit period TP, the coupling state designation circuit 34 sets the coupling state designation signal Rc[m] to the high level in the driving period TQ2. In this case, the switch Wc[m] is turned ON in the driving period TQ2. Accordingly, the ejection unit D[m] is driven by the supply drive signal Vin[m] having the waveform PA2 in the unit period TP, and ejects the ink having the ink amount ξ2 corresponding to the small dot.

Further, when the individual designation signal Sd[m] represents the value “3” that designates the ejection unit D[m] as the non-driven ejection unit DP-3 in the unit period TP, the coupling state designation circuit 34 sets the coupling state designation signal Rc[m] and the coupling state designation signal Rs[m] to the low level over the unit period TP. In this case, the switch Wc[m] and the switch Ws[m] are turned OFF over the unit period TP. Accordingly, the ejection unit D[m] is not driven by the drive signal Com in the unit period TP, and does not eject the ink.

As shown in FIG. 7, when the individual designation signal Sd[m] represents the value “4” that designates the ejection unit D[m] as the inspection target ejection unit DK in the unit period TP, the coupling state designation circuit 34 sets the coupling state designation signal Rc[m] to the high level in the control period TS1 and sets the coupling state designation signal Rs[m] to the high level in the control period TS2. In this case, the switch Wc[m] is turned ON in the control period TS1, and the switch Ws[m] is turned ON in the control period TS2. Accordingly, the vibration generated in the ejection unit D[m] remains in the control period TS2 as a result that the ejection unit D[m] designated as the inspection target ejection unit DK is driven by the supply drive signal Vin[m] having the waveform PA1 in the control period TS1. Then, in the control period TS2, the potential of the upper electrode Zu[m] provided to the ejection unit D[m] changes in accordance with the vibration which remains in the ejection unit D[m]. Then, the detection circuit 33 detects the potential of the upper electrode Zu[m] changing in accordance with the vibration remaining in the ejection unit D[m] as the vibration signal VX[m] via the switch Ws[m] in the control period TS2. That is, the waveform of the vibration signal VX[m] detected from the ejection unit D[m] in the control period TS2 represents the waveform of the vibration remaining in the ejection unit D[m] in the control period TS2. Further, the waveform of the detection signal SK[m] generated based on the vibration signal VX[m] detected from the ejection unit D[m] in the control period TS2 represents the waveform of the vibration remaining in the ejection unit D[m] in the control period TS2.

### 3. Overview of Analysis Unit 5

An overview of the analysis unit 5 will hereinafter be described with reference to FIG. 8.

As described above, the analysis unit 5 generates the period information NTC[m] representing the period TC[m] of the vibration generated in the ejection unit D[m] driven as the inspection target ejection unit DK based on the detection signal SK[m] supplied from the detection circuit 33.

FIG. 8 is a timing chart illustrating an example of the detection signal SK[m] supplied to the analysis unit 5 by the detection circuit 33. The detection signal SK[m] output by the detection circuit 33 in the control period TS2 exhibits a waveform based on the vibration remaining in the ejection unit D[m] in the control period TS2.

As shown in FIG. 8, in the control period TS2, the analysis unit 5 measures the period TC[m], which is the time length from the timing at which the potential of the detection signal SK[m] coincides with a reference potential VK0 set in the vicinity of the amplitude center of the detection signal SK[m] to the timing at which the potential subsequently coincides with the reference potential VK0, and then generates the period information NTC[m] representing that period TC[m]. Then, as described above, the rank information generation section 22 generates the attributed rank information QR based on the period information NTC[m]. Further, as described above, the ejection state inspection section 23 inspects the ejection state of the ink in the ejection unit D[m] driven as the inspection target ejection unit DK based on the period information NTC[m].

### 4. Various Types of Information Stored by Storage Unit 6

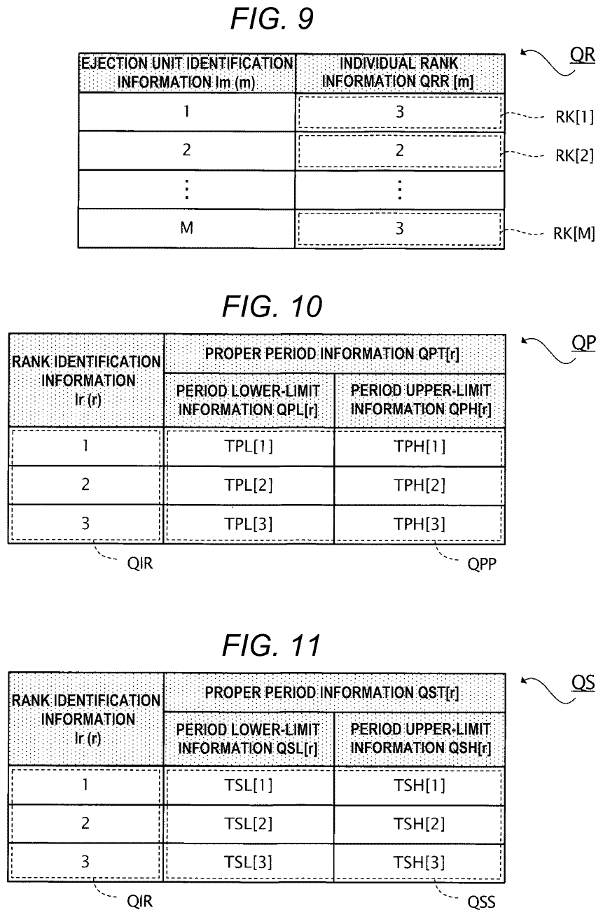

Various types of information stored by the storage unit 6 will hereinafter be described with reference to FIGS. 9 to 12.

### 4.1. Attributed Rank Information QR

FIG. 9 is a diagram illustrating an example of a data configuration of the attributed rank information QR.

As shown in FIG. 9, the attributed rank information QR includes M records corresponding one-to-one to the M ejection units D[1] to D[M] provided to the head unit 3. Each record provided to the attributed rank information QR includes ejection unit identification information Im and individual rank information QRR[m].

The ejection unit identification information Im is information for identifying each ejection unit D[m] out of the M ejection units D[1] to D[M] provided to the head unit 3. Specifically, the ejection unit identification information Im represents a value m.

The individual rank information QRR[m] represents the rank RK[m] to which the ejection unit D[m] belongs.

Note that in the present embodiment, the ejection unit D[m] is an example of a “first ejection unit”, and the individual rank information QRR[m] is an example of “first rank information”.

### 4.2. In-Preservation Proper Vibration Information QP

FIG. 10 is a diagram illustrating an example of a data configuration of the in-preservation proper vibration information QP.

As illustrated in FIG. 10, the in-preservation proper vibration information QP includes R records corresponding one-to-one to the R ranks into which the M ejection units D[1] to D[M] are classified. Each record provided to the in-preservation proper vibration information QP includes rank identification information Ir and proper period information QPT[r].

The rank identification information Ir is information for identifying each rank out of the R ranks into which the M ejection units D[1] to D[M] are classified. Specifically, the rank identification information Ir represents a value r.

The proper period information QPT[r] is information representing a proper range of the period TC[m] of the detection signal SK[m] detected from the ejection unit D[m] driven as the inspection target ejection unit DK in the state where the ejection unit D[m] belonging to the rank r is filled with the preservative solution. Here, the proper range of the period TC[m] means a range of a value which the period TC[m] of the detection signal SK[m] detected from the ejection unit D[m] driven as the inspection target ejection unit DK can take when no ejection abnormality occurs in the ejection unit D[m].

In the present embodiment, the proper period information QPT[r] includes period lower-limit information QPL[r] and period upper-limit information QPH[r].

The period lower-limit information QPL[r] represents a period TPL[r], which is a minimum value that can be taken by the period TC[m] (i.e., the period TC-P[m]) of the detection signal SK[m] detected from the ejection unit D[m] driven as the inspection target ejection unit DK in the state where the ejection unit D[m] is filled with the preservative solution when no ejection abnormality occurs in the ejection unit D[m] belonging to the rank r.

The period upper-limit information QPH[r] represents a period TPH[r], which is a maximum value that can be taken by the period TC[m] (i.e., the period TC-P[m]) of the detection signal SK[m] detected from the ejection unit D[m] driven as the inspection target ejection unit DK in the state where the ejection unit D[m] is filled with the preservative solution when no ejection abnormality occurs in the ejection unit D[m] belonging to the rank r. Note that the period TPL[r] and the period TPH[r] satisfy “TPL[r]<TPH[r]”.

Note that R pieces of rank identification information Ir provided to the in-preservation proper vibration information QP are hereinafter referred to as rank information QIR. Further, R pieces of proper period information QPT[1] to QPT[R] provided to the in-preservation proper vibration information QP are hereinafter referred to as in-preservation proper range information QPP. In the present embodiment, the in-preservation proper range information QPP is an example of “first range information”.

### 4.3. In-Use Proper Vibration Information QS

FIG. 11 is a diagram illustrating an example of a data configuration of the in-use proper vibration information QS.

As illustrated in FIG. 11, the in-use proper vibration information QS includes R records corresponding one-to-one to the R ranks into which the M ejection units D[1] to D[M] are classified. Each record provided to the in-use proper vibration information QS includes the rank identification information Ir and proper period information QST[r].

The proper period information QST[r] is information representing a proper range of the period TC[m] of the detection signal SK[m] detected from the ejection unit D[m] driven as the inspection target ejection unit DK in a state where the ejection unit D[m] belonging to the rank r is filled with the ink.

In the present embodiment, the proper period information QST[r] includes period lower-limit information QSL[r] and period upper-limit information QSH[r].

The period lower-limit information QSL[r] represents a period TSL[r], which is a minimum value that can be taken by the period TC[m] (i.e., the period TC-S[m]) of the detection signal SK[m] detected from the ejection unit D[m] driven as the inspection target ejection unit DK in the state where the ejection unit D[m] is filled with the ink when no ejection abnormality occurs in the ejection unit D[m] belonging to the rank r.

The period upper-limit information QSH[r] represents a period TSH[r], which is a maximum value that can be taken by the period TC[m] (i.e., the period TC-S[m]) of the detection signal SK[m] detected from the ejection unit D[m] driven as the inspection target ejection unit DK in the state where the ejection unit D[m] is filled with the ink when no ejection abnormality occurs in the ejection unit D[m] belonging to the rank r. Note that the period TSL[r] and the period TSH[r] satisfy “TSL[r]<TSH[r]”.

Note that the R pieces of proper period information QST[1] to QST[R] provided to the in-use proper vibration information QS are hereinafter referred to as in-use proper range information QSS. In the present embodiment, the in-use proper range information QSS is an example of “second range information”.

4.4 Relationship Between in-Preservation Proper Range Information QPP and In-Use Proper Range Information QSS

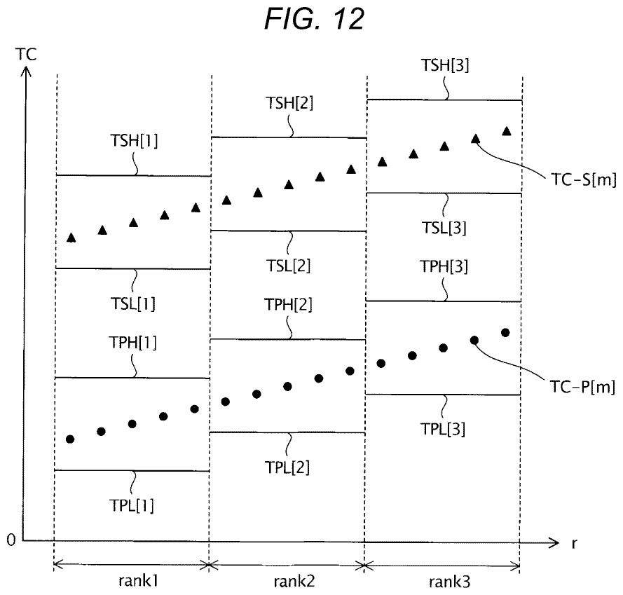

FIG. 12 is a diagram illustrating an example of a relationship between the period TPL[r] and the period TPH[r] represented by the in-preservation proper range information QPP and the period TSL[r] and the period TSH[r] represented by the in-use proper range information QSS.

In the present embodiment, as an example, there is assumed when the period TC-S[m] when the ejection unit D[m] is filled with the ink is longer than the period TC-P[m] when the ejection unit D[m] is filled with the preservative solution.

Therefore, in the present embodiment, as illustrated in FIG. 12, the period TPL[r], the period TPH[r], the period TSL[r], and the period TSH[r] are determined in advance so that a relationship of “TPL[r]<TPH[r]<TSL[r]<TSH[r]” is true.

Further, in the present embodiment, as an example, there is assumed when the period TC[m1] of the ejection unit D[m1] belonging to the rank r1 is shorter than the period TC[m2] of the ejection unit D[m2] belonging to the rank r2, that is, when “TC[m1]<TC[m2]” is true. Here, the value r1 and the value r2 are natural numbers that satisfy “1≤r1<r2≤R” and “r2=1+r1”, the value m1 is a natural number that satisfies “1≤m1≤M”, and the value m2 is a natural number that satisfies “1≤m2≤M” and “m2≠m1”.

Therefore, in the present embodiment, as an example, as shown in FIG. 11, the period TSH[r1] and the period TSH[r2] are determined in advance such that a relationship of “TSH[r1]<TSH[r2]” is true, the period TSL[r1] and the period TSL[r2] are determined in advance such that a relationship of “TSL[r1]<TSL[r2]” is true, the period TPH[r1] and the period TPH[r2] are determined in advance such that a relationship of “TPH[r1]<TPH[r2]” is true, and the period TPL[r1] and the period TPL[r2] are determined in advance such that a relationship of “TPL[r1]<TPL[r2]” is true.

Note that in the present embodiment, as an example, there is assumed when the rank information generation section 22 determines the rank r at which the difference value dPP[m][r] is maximized from the ranks 1 to R as the rank r to which the ejection unit D[m] belongs. Here, the difference value dPP[m][r] is smaller one of a difference value dPH[m][r] and a difference value dPL[m][r]. Further, the difference value dPH[m][r] is an absolute value of a difference between the period TPH[r] and the period TC-P[m]. Further, the difference value dPL[m][r] is an absolute value of a difference between the period TPL[r] and the period TC-P[m]. That is, the difference value dPP[m][r] is the shortest distance between a boundary (an upper limit and a lower limit) of the proper range of the period TC-P[m] corresponding to the rank r defined by the proper period information QPT[r] and the period TC-P[m]. In other words, in the present embodiment, as an example, the rank information generation section 22 determines the rank r to which the ejection unit D[m] belongs so as to maximize the shortest distance between the boundary (the upper limit and the lower limit) of the proper range of the period TC-P[m] of the rank r defined by the proper period information QPT[r] and the period TC-P[m].

### 5. Operation of Inkjet Printer 1

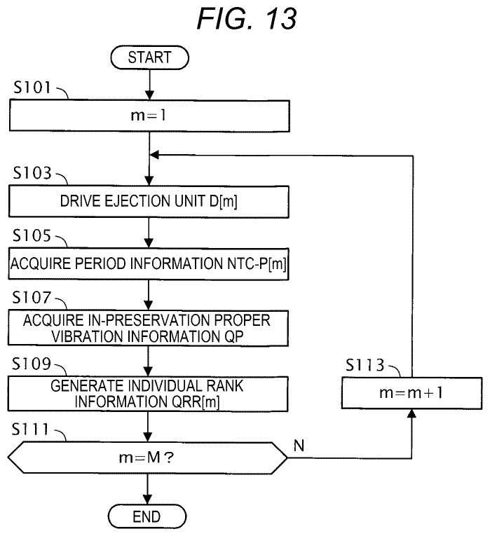

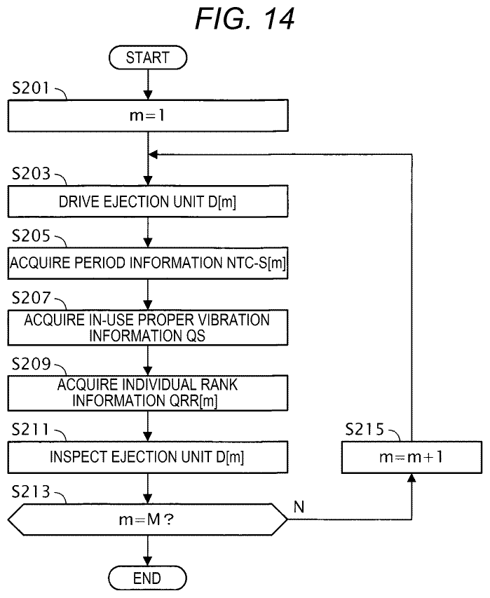

An example of an operation of the inkjet printer 1 will hereinafter be described with reference to FIGS. 13 to 14.

### 5.1. Rank Information Generation Processing

FIG. 13 is a flowchart illustrating an example of the operation of the control unit 2 when the rank information generation processing is executed. Note that as described above, the rank information generation processing is performed in a state where the ejection unit D[m] is filled with the preservative solution before shipment of the inkjet printer 1.

As illustrated in FIG. 13, when the rank information generation processing is started, the control unit 2 sets (S101) “1” to the variable m.

Then, the ejection control unit 21 drives (S103) the ejection unit D[m] as the inspection target ejection unit DK.

Specifically, in step S103, the ejection control unit 21 supplies the head unit 3 with the designation signal SI including the individual designation signal Sd[m] that designates that the ejection unit D[m] is driven as the inspection target ejection unit DK to thereby drive the ejection unit D[m] as the inspection target ejection unit DK.

Then, the rank information generation section 22 acquires (S105) the period information NTC-P[m] representing the period TC-P[m] of the detection signal SK[m] detected from the ejection unit D[m] driven as the inspection target ejection unit DK.

Then, the rank information generation section 22 acquires (S107) the in-preservation proper vibration information QP from the storage unit 6.

Subsequently, the rank information generation section 22 generates the individual rank information QRR[m] based on the period information NTC-P[m] acquired in step S105 and the in-preservation proper vibration information QP acquired in step S107 (S109).

Specifically, the rank information generation section 22 identifies the rank r at which the difference value dPP[m][r] becomes the maximum based on the period TC-P[m] represented by the period information NTC-P[m] acquired in step S105 and the periods TPL[1] to TPL[R] and the periods TPH[1] to TPH[R] represented by the in-preservation proper range information QPP in the in-preservation proper vibration information QP acquired in step S107. Then, the rank information generation section 22 generates the individual rank information QRR[m] by setting the rank r thus identified as the rank RK[m] to which the ejection unit D[m] belongs.

Then, the rank information generation section 22 determines (S111) whether the value m is “M”.

When the determination result in step S111 is negative, the rank information generation section 22 adds “1” to the value m, and the process proceeds to step S103 (S113).

When the determination result in step S111 is affirmative, the rank information generation section 22 ends the rank information generation processing.

### 5.2. Ejection State Inspection Processing

FIG. 14 is a flowchart showing an example of the operation of the control unit 2 when the ejection state inspection processing is executed. Note that as described above, the ejection state inspection processing is performed after the shipment of the inkjet printer 1 and with the ejection unit D[m] filled with the ink.

As illustrated in FIG. 14, when the ejection state inspection processing is started, the control unit 2 sets “1” to the variable m (S201).

Then, the ejection control unit 21 drives the ejection unit D[m] as the inspection target ejection unit DK (S203).

Specifically, in step S203, the ejection control unit 21 supplies the head unit 3 with the designation signal SI including the individual designation signal Sd[m] that designates that the ejection unit D[m] is driven as the inspection target ejection unit DK to thereby drive the ejection unit D[m] as the inspection target ejection unit DK.

Then, the ejection state inspection section 23 acquires the period information NTC-S[m] representing the period TC-S[m] of the detection signal SK[m] detected from the ejection unit D[m] driven as the inspection target ejection unit DK (S205).

Then, the ejection state inspection section 23 acquires the in-use proper vibration information QS from the storage unit 6 (S207).

Further, the ejection state inspection section 23 acquires the individual rank information QRR[m] corresponding to the ejection unit D[m] from the storage unit 6 (S209).

Subsequently, the ejection state inspection section 23 inspects the ejection unit D[m] based on the period information NTC-S[m] acquired in step S205, the in-use proper vibration information QS acquired in step S207, and the individual rank information QRR[m] acquired in step S209 (S211).

Specifically, the ejection state inspection section 23 first selects the proper period information QST[r] corresponding to the rank RK[m] represented by the individual rank information QRR[m] acquired in step S209, from the R pieces of proper period information QST[1] to QST[R] provided to the in-use proper vibration information QS acquired in step S207. Then, the ejection state inspection section 23 determines whether “TSL[r]≤TC-S[m]≤TSH[r]” is true based on the period TSL[r] and the period TSH[r] represented by the proper period information QST[r] thus selected and the period TC-S[m] represented by the period information NTC-S[m] acquired in step S205. Then, when the result of the determination is affirmative, the ejection state inspection section 23 generates information representing an inspection result representing that the ejection state of the ink in the ejection unit D[m] is normal, and stores the information thus generated in the storage unit 6. On the other hand, when the determination result is negative, the ejection state inspection section 23 generates information representing the inspection result that the ejection abnormality has occurred in the ejection unit D[m], and stores the information thus generated in the storage unit 6.

Then, the ejection state inspection section 23 determines (S213) whether the value m is “M”.

When the determination result in step S213 is negative, the ejection state inspection section 23 adds (S215) “1” to the value m, and the process proceeds to step S203.

When the determination result in step S213 is affirmative, the ejection state inspection section 23 ends the ejection state inspection processing.

### 6. Connection of Present Embodiment

As described above, in the present embodiment, the inkjet printer 1 executes the rank information generation processing in the state where the ejection unit D[m] is filled with the preservative solution, and executes the print processing and the rank information generation processing in the state where the ejection unit D[m] is filled with the ink. Therefore, according to the present embodiment, it is possible to suppress an amount of the ink used, compared to the related art configuration in which the rank information generation processing is executed in the state where the ejection unit D[m] is filled with the ink.

Further, when it is necessary to execute the rank information generation processing in the state where the ejection unit D[m] is filled with as in the related-art configuration, it is necessary to execute the rank information generation processing after changing the liquid, with which the ejection unit D[m] is filled, from the preservative solution to the ink, for example, before shipment of the inkjet printer 1, and then, restore the preservative solution from the ink as the liquid with which the ejection unit D[m] is filled after the rank information generation processing ends. In contrast, in the present embodiment, the rank information generation processing can be executed without changing the liquid with which the ejection unit D[m] is filled from the preservative solution before shipment of the inkjet printer 1. That is, in the present embodiment, it becomes possible to reduce the load related to the preparation work for executing the rank information generation processing and it becomes also possible to reduce the load related to the postwork from the execution of the rank information generation processing to the shipment of the inkjet printer 1 compared to the aspect in which it is necessary to execute the rank information generation processing in the state where the ejection unit D[m] is filled with the ink.

### B. Modified Examples

The aspects described hereinabove can variously be modified. Specific aspects of the modifications will be exemplified below. Two or more aspects randomly selected from the following exemplifications can be combined as appropriate within a range where the aspects are mutually consistent. Note that in the modified examples exemplified below, elements having equivalent actions and functions to those of the present embodiment are denoted by the signs referred to in the above description to omit the detailed description thereof as appropriate.

### B. 1. Modified Example 1

In the embodiment described above, the description is presented exemplifying the aspect in which the attributed rank information QR is generated in the control unit 2, and the ejection state of the ink in the ejection unit D is inspected in the control unit 2, but the present disclosure is not limited to such an aspect. One or both of the generation of the attributed rank information QR and the inspection of the ejection state of the ink in the ejection unit D may be executed by a constituent different from the control unit 2.

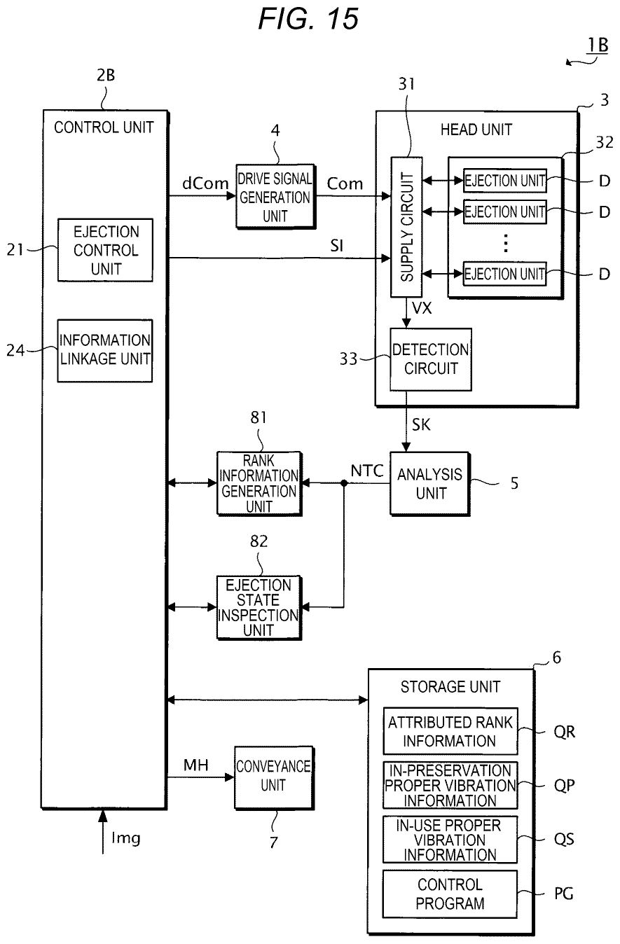

FIG. 15 is a functional block diagram showing an example of a configuration of an inkjet printer 1B according to Modified Example 1.

As shown in FIG. 15, the inkjet printer 1B is configured similarly to the inkjet printer 1 according to the embodiment described above except a point that the inkjet printer 1B includes a control unit 2B instead of the control unit 2, a point that a rank information generation unit 81 is provided, and a point that an ejection state inspection unit 82 is provided.

Similarly to the rank information generation section 22, the rank information generation unit 81 generates the attributed rank information QR based on the in-preservation proper vibration information QP and the period information NTC[m].

Similarly to the ejection state inspection section 23, the ejection state inspection unit 82 inspects the ejection state of the ink in the ejection unit D based on the individual rank information QRR[m], the in-use proper vibration information QS, and the period information NTC[m].

Note that in the present modified example, the rank information generation unit 81 is an example of the “generation section”, and the ejection state inspection unit 82 is an example of the “inspection section”.

The control unit 2B is configured similarly to the control unit 2 related to the embodiment described above except the point that an information linkage unit 24 is provided, a point that the rank information generation section 22 is not provided, and a point that the ejection state inspection section 23 is not provided.

The information linkage unit 24 supplies the in-preservation proper vibration information QP acquired from the storage unit 6 to the rank information generation unit 81, supplies the in-use proper vibration information QS and the individual rank information QRR[m] acquired from the storage unit 6 to the ejection state inspection unit 82, stores the attributed rank information QR generated by the rank information generation unit 81 in the storage unit 6, and stores the result of the inspection of the ejection state of the ink in the ejection unit D executed by the ejection state inspection unit 82 in the storage unit 6.

Also in the present modified example, the inkjet printer 1B can execute the rank information generation processing in the state where the ejection unit D[m] is filled with the preservative solution, and therefore, becomes possible to reduce the amount of the ink used, and to reduce the load related to the preparation work for executing the rank information generation processing compared to the related-art aspect in which the rank information generation processing is executed in the state where the ejection unit D[m] is filled with the ink.

Note that in the present modified example, the analysis unit 5, the rank information generation unit 81, and the ejection state inspection unit 82 may be mounted on the head unit 3.

### B. 2. Modified Example 2

In the embodiment and Modified Example 1 described above, there is assumed when the inkjet printer 1 includes the four head units 3 and the four analysis units 5, however, the present disclosure is not limited to such a configuration. The inkjet printer 1 may include one or more and three of less head units 3 and analysis units 5, or may include five or more head units 3 and analysis units 5.

### B. 3. Modified Example 3

In the embodiment and Modified Examples 1 and 2 described above, there is exemplified when the inkjet printer 1 is a serial printer, however, the present disclosure is not limited to such a configuration. The inkjet printer 1 may be a so-called line printer in which a plurality of nozzles N is disposed so as to extend to be wider than the width of the recording paper PP in the head unit 3.

### C. Supplementary Notes

Aspects related to the above description will hereinafter be described below as supplementary notes. In order to facilitate understanding of the aspects, reference numerals in the drawings are added in parentheses for the sake of convenience in the following description, but it is not intended to limit the present disclosure to the illustrated aspects.

### C.1. Supplementary Note 1

The inkjet printer 1 according to Supplementary Note 1 includes M ejection units D[1] to D[M] filled with the liquid and capable of ejecting the liquid with which the M ejection units D[1] to D[M] are filled, the rank information generation section 22 configured to generate the individual rank information QRR[m] based on the detection result of the vibration generated in the ejection unit D[m] in the state where the ejection unit D[m] out of the M ejection units D[1] to D[M] is filled with the preservative solution, and the ejection state inspection section 23 configured to inspect the ejection state of the ink in the ejection unit D[m] based on the detection result of the vibration generated in the ejection unit D[m] in the state where the ejection unit D[m] is filled with the ink and the individual rank information QRR[m], wherein the individual rank information QRR[m] represents the rank RK[m] to which the ejection unit D[m] belongs when classifying the M ejection units D[1] to D[M] into the R ranks based on the period TC[m] of the vibration generated in each ejection unit D.

According to the Supplementary Note 1, since the inkjet printer 1 can generate the individual rank information QRR[m] in the state where the ejection unit D[m] is filled with the preservative solution, it becomes possible to reduce the amount of ink used, and it becomes possible to reduce the load related to the preparation work for generating the individual rank information QRR[m] compared to the aspect the individual rank information QRR[m] is generated in the state where the ejection unit D[m] is filled with the ink.

### C.2. Supplementary Note 2

The inkjet printer 1 according to Supplementary Note 2 is the inkjet printer 1 according to Supplementary Note 1, wherein the ink is a liquid used in a print processing of forming an image on the recording paper PP, and the preservative solution is a liquid not used in the print processing.

According to Supplementary Note 2, it becomes possible to reduce the amount of ink used compared to the aspect in which the individual rank information QRR[m] is generated in the state where the ejection unit D[m] is filled with the ink.

### C.3. Supplementary Note 3

The inkjet printer 1 according to Supplementary Note 3 is the inkjet printer 1 according to Supplementary Note 1 or Supplementary Note 2, wherein the ink is a liquid used in the print processing of forming an image on the recording paper PP, and the preservative solution is a liquid for cleaning a flow path communicating with the ejection unit D[m].

According to Supplementary Note 3, since the individual rank information QRR[m] can be generated in the process of cleaning the flow path communicating with the ejection unit D[m] before shipment or the like of the inkjet printer 1, it is possible to reduce the load related to the generation of the individual rank information QRR[m] compared to the aspect in which the individual rank information QRR[m] is generated in the state where the ejection unit D[m] is filled with the ink.

### C.4. Supplementary Note 4

The inkjet printer 1 according to Supplementary Note 4 is the inkjet printer 1 according to Supplementary Notes 1 to 3, wherein the ink is a liquid used in the print processing of forming an image on the recording paper PP, and the preservative solution is the antifreeze liquid.

According to Supplementary Note 4, since the individual rank information QRR[m] can be generated in the state where the ejection unit D[m] is filled with the antifreeze liquid before shipment or the like of the inkjet printer 1, it is possible to reduce the load related to the generation of the individual rank information QRR[m] compared to the aspect in which the individual rank information QRR[m] is generated in the state where the ejection unit D[m] is filled with the ink.

### C.5. Supplementary Note 5

The inkjet printer 1 according to Supplementary Note 5 is the inkjet printer 1 according to any one of Supplementary Notes 1 to 4, wherein the rank information generation section 22 is configured to generate the individual rank information QRR[m] based on the detection result of the vibration generated in the ejection unit D[m] in the state where the ejection unit D[m] is filled with the preservative solution, and the in-preservation proper vibration information QP, and the in-preservation proper vibration information QP includes the in-preservation proper range information QPP representing the proper range of the period TC[m] of the vibration generated in the ejection unit D[m] in the state where the ejection unit D[m] belonging to the rank r out of the R ranks is filled with the preservative solution when classifying the M ejection units D[1] to D[M] into the R ranks based on the period TC[m] generated in each ejection unit D.

### C.6. Supplementary Note 6

The inkjet printer 1 according to Supplementary Note 6 is the inkjet printer 1 according to any one of Supplementary Notes 1 to 5, wherein the ejection state inspection section 23 inspects the ejection unit D[m] based on the detection result of the vibration generated in the ejection unit D[m] in the state where the ejection unit D[m] is filled with the ink, and the in-use proper vibration information QS, and the in-use proper vibration information QS includes the in-use proper range information QSS representing the proper range of the period TC[m] of the vibration generated in the ejection unit D[m] in the state where the ejection unit D[m] belonging to the rank r out of the R ranks is filled with the ink.

What is claimed is:

1. A liquid ejection apparatus comprising:
a plurality of ejection units which is filled with a liquid, and is configured to eject the liquid with which the plurality of ejection units is filled;
a generation section configured to generate first rank information based on a detection result of a vibration generated in a first ejection unit out of the plurality of ejection units in a state where the first ejection unit is filled with a first liquid; and
an inspection section configured to inspect the first ejection unit based on a detection result of a vibration generated in the first ejection unit in a state where the first ejection unit is filled with a second liquid, and the first rank information wherein
the first rank information represents a rank to which the first ejection unit belongs when classifying the plurality of ejection units into a plurality of ranks based on vibration characteristics of the plurality of ejection units.

2. The liquid ejection apparatus according to claim 1, wherein
the second liquid is a liquid used in a print processing of forming an image on a medium, and
the first liquid is a liquid not used in the print processing.

3. The liquid ejection apparatus according to claim 1, wherein
the second liquid is a liquid used in a print processing of forming an image on a medium, and
the first liquid is a liquid configured to clean a flow path communicating with the first ejection unit.

4. The liquid ejection apparatus according to claim 1, wherein
the second liquid is a liquid used in a print processing of forming an image on a medium, and
the first liquid is an antifreeze liquid.

5. The liquid ejection apparatus according to claim 1, wherein
the generation section generates the first rank information based on the detection result of the vibration generated in the first ejection unit in the state where the first ejection unit is filled with the first liquid, and first reference information, and
the first reference information includes first range information representing a proper range of a characteristic of a vibration generated in one of the ejection units belonging to one of the plurality of ranks in a state where the one of the plurality of ejection units is filled with the first liquid when classifying the plurality of ejection units into a plurality of ranks based on vibration characteristics of the plurality of ejection units.

6. The liquid ejection apparatus according to claim 5, wherein
the inspection section inspects the first ejection unit based on the detection result of the vibration generated in the first ejection unit in the state where the first ejection unit is filled with the second liquid, and second reference information, and
the second reference information includes second range information representing a proper range of a characteristic of a vibration generated in one of the plurality of ejection units belonging to one of the plurality of ranks in a state where the one of the plurality of ejection units is filled with the second liquid.

7. A method of inspecting a liquid ejection apparatus including a plurality of ejection units configured to eject a liquid with which the plurality of ejection units is filled, the method comprising:
generating first rank information based on a detection result of a vibration generated in a first ejection unit out of the plurality of ejection units in a state where the first ejection unit is filled with a first liquid; and
inspecting the first ejection unit based on a detection result of a vibration generated in the first ejection unit in a state where the first ejection unit is filled with a second liquid, and the first rank information wherein
the first rank information represents a rank to which the first ejection unit belongs when classifying the plurality of ejection units into a plurality of ranks based on vibration characteristics of the plurality of ejection units.

8. The method according to claim 7, wherein
the second liquid is a liquid used in a print processing of forming an image on a medium, and
the first liquid is a liquid not used in the print processing.

9. The method according to claim 7, wherein
the second liquid is a liquid used in a print processing of forming an image on a medium, and
the first liquid is a liquid configured to clean a flow path communicating with the first ejection unit.

10. The method according to claim 7, wherein
the second liquid is a liquid used in a print processing of forming an image on a medium, and
the first liquid is an antifreeze liquid.

11. The method according to claim 7, comprising:
generating the first rank information based on the detection result of the vibration generated in the first ejection unit in the state where the first ejection unit is filled with the first liquid, and first reference information, wherein
the first reference information includes first range information representing a proper range of a characteristic of a vibration generated in one of the ejection units belonging to one of the plurality of ranks in a state where the one of the plurality of ejection units is filled with the first liquid when classifying the plurality of ejection units into a plurality of ranks based on vibration characteristics of the plurality of ejection units.

12. The method according to claim 11, comprising:
inspecting the first ejection unit based on the detection result of the vibration generated in the first ejection unit in the state where the first ejection unit is filled with the second liquid, and second reference information, wherein
the second reference information includes second range information representing a proper range of a characteristic of a vibration generated in one of the plurality of ejection units belonging to one of the plurality of ranks in a state where the one of the plurality of ejection units is filled with the second liquid.
